(19) United States
(12) Patent Application Publication
(10) Pub. No.: US 2026/0267290 A1
(43) Pub. Date: Sep. 10, 2026

(54) TIMEPIECE COMPRISING A DEVICE FOR SETTING A TARGET TIME

(71) Applicant: PARMIGIANI FLEURIER SA, Fleurier (CH)

(72) Inventors: Guido Terreni, Fleurier (CH); Guillaume Lewis, Fleurier (CH); Laurent Wiederrecht, Meyrin (CH)

(21) Appl. No.: 19/162,882

(22) PCT Filed: Mar. 15, 2024
(86) PCT No.: PCT/IB2024/052538

§ 371 Date: Sep. 5, 2025

(30) Foreign Application Priority Data
Mar. 15, 2023 (CH) CH000290/2023

(51) Int. Cl. G04B 19/28; G04B 19/04

(52) U.S. Cl. CPC G04B 19/28; G04B 19/04

(57) ABSTRACT

The present invention relates to a mechanical timepiece comprising a movement arranged to drive a minute display member (1) and an hour display member (2), a means (3) for controlling the minute display member (1) and the hour display member (2) arranged to move, on demand, the minute display member (1) and the hour display member (2), a target time display member (6), a control means (4, 5) arranged to move, on demand, the target time display member (6), and a means (7) for resetting the target time display member (6).

The present invention relates to a timepiece comprising a device for setting a target time enabling relative time counting.

Timepieces and other time-indicating devices, in particular for counting down time, are known from the state of the art. In particular, timepieces which are provided with a timer that is triggered selectively and manually by the user.

For example, document U.S. Pat. No. 1,790,359 describes a device whereby a watch with a conventional time display using minute and hour hands can be equipped with additional minute and hour hands in order to display the time difference between the start of an event and the current time. In this case, the additional minute and hour hands are set manually, so the position of the additional minute and hour hands is always stationary as long as they are not moved manually. The use of such a manual device is obviously tedious, time-consuming and interferes with normal time reading.

U.S. Pat. No. 5,255,248 describes a watch that allows both the normal display of the time and the measurement of a time difference, without being a chronograph, but which integrates both functions in a single display.

The watch proposed in this patent document has an additional minute hand, arranged coaxially with the hands of the normal time display, which can be brought from a normal stationary position to the current position of the normal minute hand by operating a push-button. It remains stationary to mark the start of an event. According to the document, the step that consists in placing the additional hand at the current time can be carried out by means of a conventional split-hand mechanism.

Additionally, the described watch has a ring rotating coaxially around the dial, with a marker and a scale, to mark the end of the event, for example, and thus to incorporate a “timer” function.

While this watch allows both the normal display of the time and the measurement of a time difference, with a ratchet mechanism proposed to move the additional minute hand, the reading of the corresponding indications is not optimal insofar as the additional minute hand only has stationary positions, as previously stated, and therefore has an entirely negative impact on the reading of the normal time display when its measuring or marking function is not used. Indeed, this hand remains in its last position of use, and is therefore permanently visible on the dial as a disturbing element

EP1491972B1 discloses a wristwatch, including an analog time display and comprising at least one minute hand and one hour hand and a split-hand mechanism including at least one split-minute hand and one split-hour hand arranged coaxially with the hands of the normal time display. In a normal mode of the watch, the split hand or hands move synchronously with the hands of the normal time display and are stacked with same, and they are locked in a stop mode in order to mark a desired time and, after a desired time interval has elapsed, move again synchronously with the hands of the normal time display in a position stacked with same.

The aim of the present invention is to enable the normal display of the time and the measurement of a time difference simultaneously, in direct relation to each other, and in an efficient and simple manner, without the presence of the additional display members adversely affecting the normal time display when these additional display members are not in use.

Thus, the present invention makes it possible to offer a solution which, in a particularly simple way, provides an indication of the time remaining before the conclusion of a set time, such as a timer, but also an indication of the time counted beyond the set time, thus enabling relative time counting.

The advantages of such a timepiece include providing a novel function, similar to a combination of a timer and a conventional chronograph with its secondary dials, ease of use, good estimation and legibility of the duration of an operation, and the wide range of applications of this watch.

In accordance with the invention, a mechanical timepiece comprises:
a movement arranged to drive a minute display member and an hour display member;
a first means for controlling the minute display member and the hour display member, arranged to move, on demand, the minute display member and the hour display member;
a target time display member;
at least one second control means arranged to move, on demand, the target time display member, and
a means for resetting the target time display member,
   wherein, during normal operation of the timepiece to display the time, said target time display member is placed beneath and concealed by the minute display member or the hour display member so that the minute display member and the hour display member display the time.

According to the invention, the second control means is arranged to move the target time display member with respect to the minute display member or the hour display member every time the control means is pressed by an incremental value to determine a target time to be reached by successive actuations of the control means.

Additionally, when it is activated, the means for resetting the target time display member is arranged to move the target time display member so that it is placed beneath the minute display member or the hour display member in its normal time display position, so that the timepiece displays the time according to its normal operating state without displaying a target time.

In one embodiment, a further control means comprises a first push-button for moving the target time display member by a fraction of an hour and a second push-button for moving the target time display member by another different fraction of an hour, the target time display member moving with respect to the time display member beneath which it is arranged.

In a preferred embodiment, a further control means comprises a first push-button for moving the target time display member by one minute and a second push-button for moving the target time display member by five minutes, the target time display member moving with respect to the time display member beneath which it is arranged.

In one embodiment, the target time display member moves in the clockwise direction when it is actuated, and when the reset means is actuated, the target time display member moves to be stacked above or beneath the minute display member or the hour display member in the clockwise or counter-clockwise direction, that is, according to the appropriate and more efficient direction of rotation.

In one embodiment, the hour display member, the minute display member and the target time display member are a hand or another hand-like time indicator member, rotated in front of a dial bearing a series of time indications.

In one embodiment, the hour display member, the minute display member and the target time display member are a disc or a crown.

The invention relates to a timepiece in the form of a wristwatch, a pocket watch, a table clock or a wall clock.

The features of the invention will become clearer upon reading the description of several embodiments given solely by way of example, which is in no way limiting, with reference to the schematic figures, wherein:

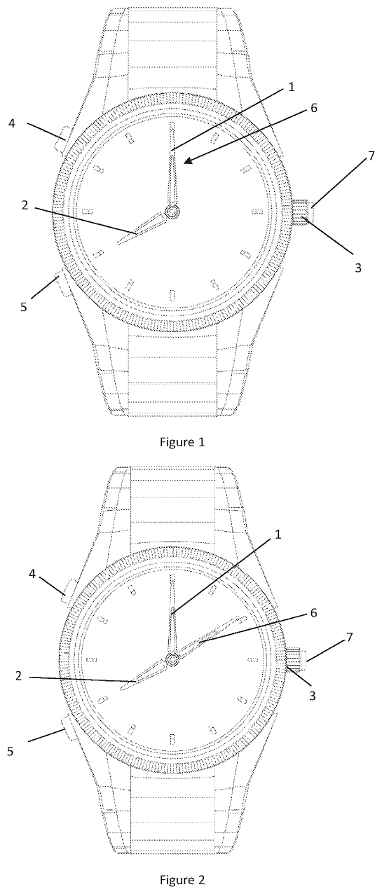

FIG. 1 depicts a timepiece in normal operation displaying 8 o'clock with the target minute hand concealed beneath the minute hand;

FIG. 2 depicts the timepiece of FIG. 1 on which the target minute hand is visible and is positioned 9 minutes after the minute hand displaying the current time;

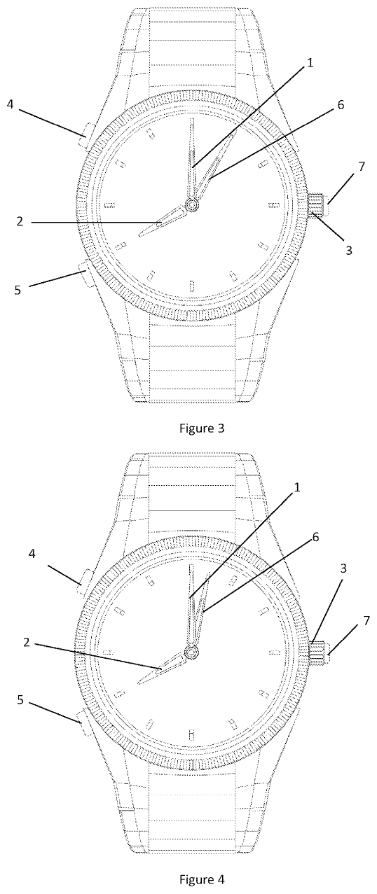

FIG. 3 depicts the timepiece of FIG. 1 on which the target minute hand is visible and is positioned 5 minutes after the minute hand displaying the current time; and

FIG. 4 depicts the timepiece of FIG. 1 on which the target minute hand is visible and is positioned 2 minutes after the minute hand displaying the current time;

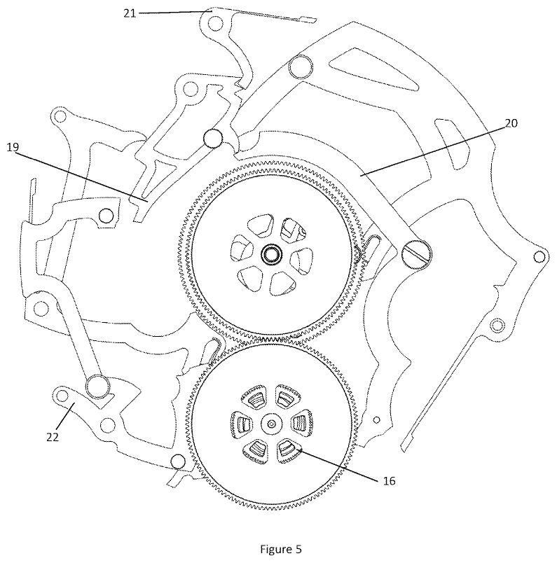

FIG. 5 depicts one embodiment of a mechanism for implementing the target time and for correcting same;

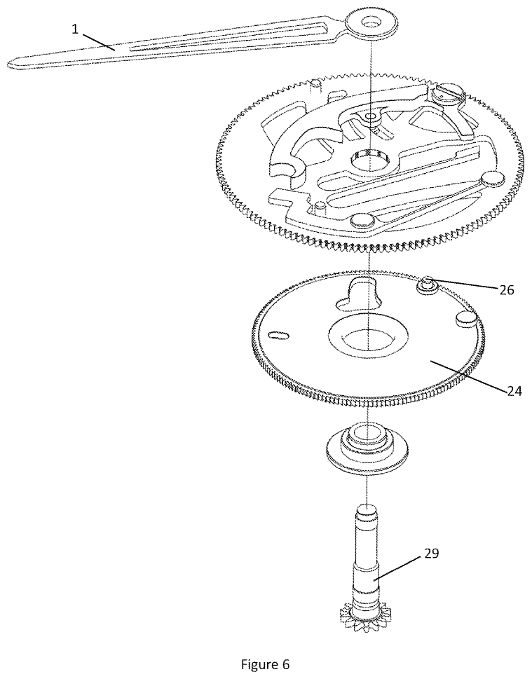

FIG. 6 depicts one embodiment of a minute mobile of the mechanism of FIG. 5;

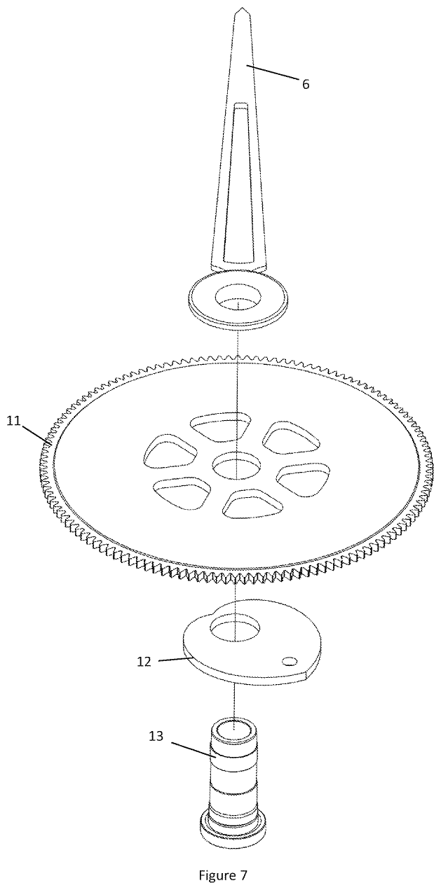

FIG. 7 depicts one embodiment of a display mobile of the mechanism of FIG. 5;

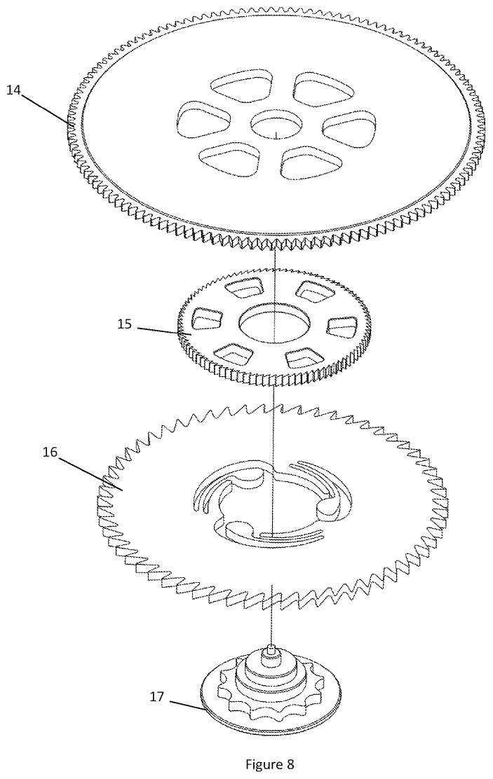

FIG. 8 depicts one embodiment of a shifting mobile of the mechanism of FIG. 5;

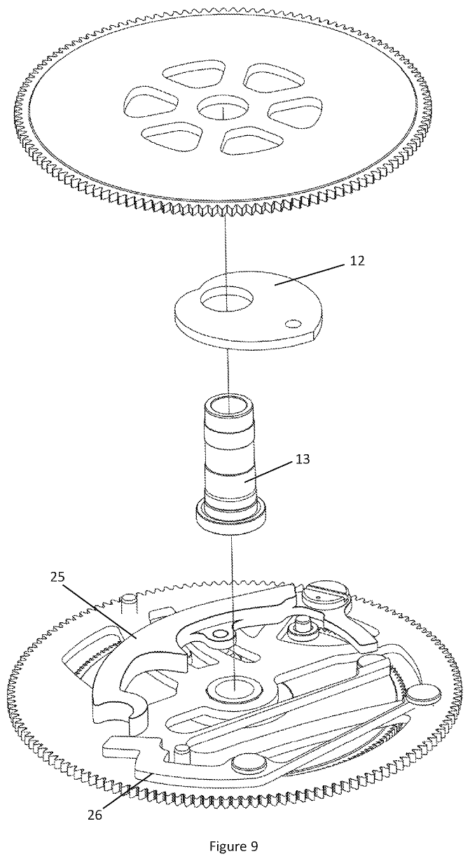

FIG. 9 depicts one embodiment of the arrangement of a display mobile and a minute mobile according to the mechanism of FIG. 5;

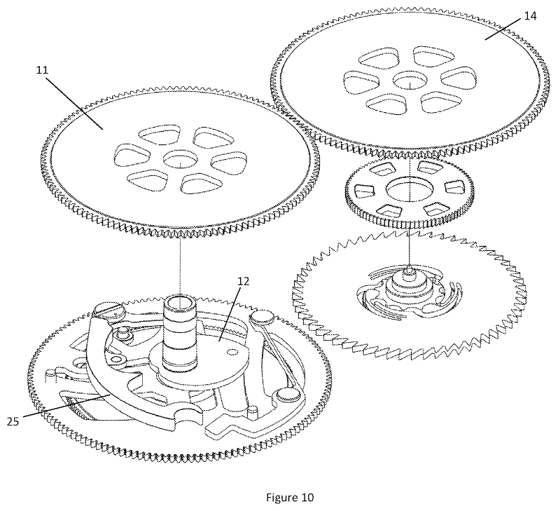

FIG. 10 depicts a perspective view of a connection between a shifting mobile and a mobile according to the mechanism of FIG. 5;

FIG. 11 depicts a minute-by-minute correction mechanism of the mechanism of FIG. 5;

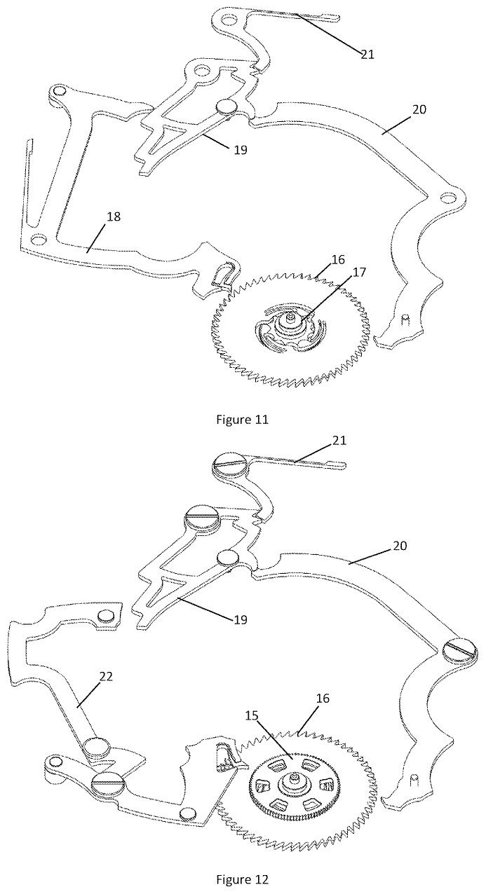

FIG. 12 depicts a five-minute correction mechanism for the mechanism of FIG. 5;

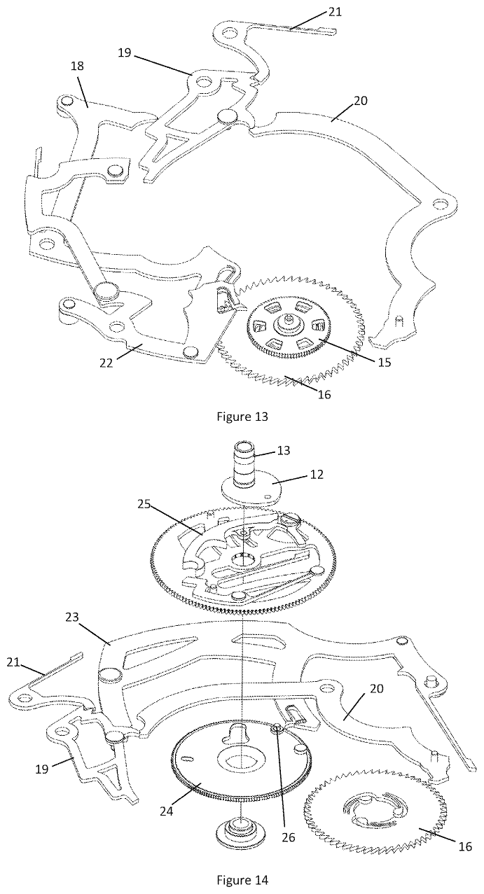

FIG. 13 depicts and overview of the correction mechanism of the mechanism of FIG. 5; and

FIG. 14 depicts a perspective view of the zero-reset mechanism of the mechanism of FIG. 5

As exemplified in FIG. 1, a mechanical timepiece comprising a movement arranged to drive a minute display hand 1 and an hour display hand 2, a means for controlling the minute display hand 1 and the hour display hand 2 in the form of a winding crown 3, the winding crown being arranged to move, on demand, the minute display hand 1 and the hour display hand 2, as well as the target time display hand 6 when it is aligned with the minute display hand 1.

The timepiece comprises a target time display hand 6 (stacked with or placed beneath the minute hand 1), two push-buttons 4, 5 arranged to move, on demand, the target time display hand 6 and a resetting means 7 for resetting the target time display member 6 in the form of a push-button positioned at the winding crown 3.

In this example, during normal operation of the timepiece to display the time, the target time display hand 6 is stacked on or placed beneath and concealed by the minute display hand 1, so that the minute display hand 1 and the hour display hand 2 display the time.

The push-buttons 4, 5 are arranged to move the target time display hand 6 with respect to the minute display hand 1 every time one of the two push-buttons 4, 5 is pressed by an incremental value in order to determine a target time to be reached by successive actuations of each of the push-buttons 4, 5.

When it is activated, the reset push-button 7 for the target time display hand 6 is arranged to move the target time display hand 6 so that it rests above or beneath the minute display member 1, thus switching the timepiece to its normal operating state in order to display the time.

In this example, the timepiece indicates that it is 8 o'clock.

FIG. 2 shows the timepiece with a different display. In this example, the target time display hand 6 is positioned nine minutes after the minute display hand 1. To achieve this, one press on the push-button 4 positioned at 10 o'clock moves the target time display hand 6 by five minutes with respect to the minute display hand 1 beneath which it was concealed, and then four successive presses on the push-button 5 positioned at 8 o'clock move the target time display hand 6 by four minutes with respect to the minute display hand 1.

The minute display hand 1 and the hour display hand 2 display the current time, which in this example is 8 o'clock.

The target time display hand 6 has therefore been moved by nine minutes. The target time hand 6 remains stationary during the normal advance of the minute hand 1. In this way, it is possible to see when the minute hand 1, through its normal advance, reaches the target time hand 6. It is also easy to see and measure by how far the minute hand 1 exceeds the target hand 6 during the normal advance of the minute hand 1 beyond the position of the target hand 6.

Once the target time has been set, the reset push-button 7 for the target time display hand 6, when it is activated, makes it possible to move the target time display hand 6 so as to make it align with the minute display member 1 in its time display position, thus switching the timepiece to its normal operating state in order to display the time.

In the example exemplified in FIG. 3, the target time display hand 6 is positioned five minutes after the minute display hand 1 by pressing the push-button 4 positioned at 10 o'clock, which moves the target time display hand 6 by five minutes with respect to the minute display hand 1 beneath or above which it was concealed.

The minute display hand 1 and the hour display hand 2 display the current time, which in this example is 8 o'clock.

The target time display hand 6 has therefore been moved by five minutes. The target time hand 6 remains stationary during the normal advance of the minute hand 1. Thus, it is possible to see when the minute hand 1 reaches the target time hand 6. It is also easy to see and measure by how far the minute hand 1 exceeds the target hand 6 during the normal advance of the minute hand 1 beyond the position of the target hand 6.

Once the measurement has been taken, when it is activated, the reset push-button 7 for the target time display hand 6 is arranged to move the target time display hand 6 so that it rests above or beneath the minute display member 1 in its time display position, thus switching the timepiece to its normal operating state in order to display the time.

In the example of FIG. 4, the target time display hand 6 is positioned two minutes after the minute display hand 1 by two successive presses on the push-button 5 positioned at 8 o'clock.

The minute display hand 1 and the hour display hand 2 display the current time, which in this example is 8 o'clock.

The target time display hand 6 has therefore been moved by two minutes. The target time hand 6 remains stationary during the normal advance of the minute hand 1. Thus, it is possible to see when the minute hand 1 reaches the target time hand 6. It is also easy to see and measure by how far the minute hand 1 exceeds the target hand 6 during the normal advance of the minute hand 1 beyond the position of the target hand 6.

Once the measurement has been taken, when it is activated, the reset push-button 7 for the target time display hand 6 is arranged to move the target time display hand 6 so that it is placed beneath or above the minute display member 1 in its time display position, thus switching the timepiece to its normal operating state in order to display the time.

In one variant not exemplified, two target time display hands can be combined to indicate, for example, a timer with a duration of 1 h 30 min.

In another variant not exemplified, it is possible to only keep one hand for displaying a target time coupled with a counter visible through an aperture on the dial, the aperture having another primary function, such as displaying a date for example.

FIG. 5 depicts a mechanism for implementing a target time display function and for resetting same, the mechanism comprising:
A minute mobile arranged to synchronize a target time hand or split-minute hand with a conventional minute hand displaying the current time;
A display mobile arranged to display the split-minute hand;
A shifting mobile arranged to control the position of the split-minute hand;
A minute correction system, and
A reset system.

As exemplified in FIG. 6, a minute mobile rotates with a cannon pinion of the movement 29, performing one revolution per hour. The minute mobile is used to synchronize the split-minute hand 6 with the conventional minute hand 1, which is press-fit onto the cannon pinion of the movement 29.

FIG. 7 depicts a display mobile onto which a split-minute hand 6 is press-fit. The display mobile consists of a display wheel 11 and a zero-reset heart cam 12, both press-fit onto a pipe 13.

As exemplified in FIG. 8, a shifting mobile controls the position of the split-minute hand 6. The shifting mobile consists of a shifting wheel 14 and a wolf-tooth shifting wheel 15 press-fit onto the shifting arbor 17, while a star wheel 16 is positioned on the arbor by means of three central springs integrated into said star wheel. When a force is applied to the star wheel 16, the whole shifting mobile begins to rotate. When a force is applied to the wolf-tooth shifting wheel 15, the entire mobile except for the star wheel 6 begins to rotate.

As exemplified in FIG. 9, the minute mobile and the display mobile are concentric, so that the conventional minute hand 1 and the target time hand or split hand can be stacked

As exemplified in FIG. 10, the display wheel 11 and the shifting wheel 14 are permanently engaging, enabling the movement of the shifting mobile to be transmitted to the display mobile

As exemplified in FIG. 11, when the +1 minute button is first pressed, a first rocker 18 simultaneously pivots the sixty-tooth star wheel 16 by one tooth and rotates a second rocker 19 in the counter-clockwise direction. When pushed, the second rocker 19 releases a first jumper 20, which then positions the star wheel 16.

On subsequent presses, the first rocker 18 is only used to rotate the star wheel 16, since the second rocker 19 is held in the pushed position by a second jumper 21. The star wheel 16 drives the entire shifting mobile.

As exemplified in FIG. 12, when the +5 minute button is first pressed, the third rocker 22 simultaneously rotates the wolf-tooth shifting wheel 15 and rotates the second rocker 19 in the counter-clockwise direction.

When pushed, the second rocker 19 releases the first jumper 20, which then positions the star wheel 16.

On subsequent presses, the third rocker 22 is only used to rotate the wolf-tooth shifting wheel 15, since the second rocker 19 is held in the pushed position by the second jumper 21.

The wolf-tooth shifting wheel 15 rotates the shifting arbor 17, but the star wheel 16 remains stationary by virtue of the shape of the arbor 17 and the central springs machined into the star wheel 16. These geometries allow the arbor to rotate by exactly 30°, equivalent to 5 minutes.

FIG. 13 depicts a perspective view of a minute-correction system.

As exemplified in FIG. 14, when the zero-reset button is pressed, initially, a fourth rocker 23 pushes the second rocker 19 to pivot it in the clockwise direction, thus allowing the first jumper 10 to disengage from the teeth of the sixty-tooth star wheel 16.

Subsequently, the fourth rocker 23 engages with a wolf-tooth wheel 24, causing it to rotate. Since a pin 26 is press-fit onto the wolf-tooth wheel 24, it too begins to rotate.

The pin 26 comes into contact with a hammer 25, which tilts and rests on the zero-reset heart cam 12, thus synchronizing the display mobile with the minute mobile.

In summary, the timepiece according to the invention allows the normal display of the time and the measurement and indication of a time difference or target time simultaneously, in direct relation to each other, and in an efficient and simple manner. In a particularly simple way, it also provides an indication of the time remaining before the end of a given time, like a timer, as well as an indication of the time counted beyond a given indicated time.

Of course, such a timepiece is driven by a mechanical watch movement including a mechanism for driving the target time display members, especially a split-hand mechanism that is known in the state of the art.

1. A mechanical timepiece, comprising:
a movement arranged to drive a minute display member (1) and an hour display member (2);
a first means (3) for controlling the minute display member (1) and the hour display member (2), arranged to move, on demand, said minute display member (1) and hour display member (2);
a target time display member (6) arranged to be moved by the first control means (3) when the target time display member (6) and the minute display member (1) or the hour display member (2) are aligned;
a second control means (4, 5) arranged to move, on demand, the target time display member (6), and
a means (7) for resetting the target time display member (6),
wherein, during normal operation of the timepiece to display the time, said target time display member (6) is placed beneath or above and concealed by the minute display member (1) or the hour display member (2) so that the minute display member (1) and the hour display member (2) display the time;
characterized in that
the second control means (4, 5) is arranged to move the target time display member with respect to the minute display member (1) or the hour display member (2) every time the control means (4, 5) is pressed by an incremental value to determine a target time to be reached by successive actuations of the control means (4, 5), and
when it is activated, the means (7) for resetting the target time display member (6) is arranged to move the target time display member (6) so that it rests above or beneath the minute display member (1) or the hour display member (2) in its normal time display position, so that the timepiece displays the time according to its normal operating state without displaying a target time.

2. The timepiece according to claim 1, wherein the second control means comprises a first push-button (4) for moving the target time display member by a fraction of an hour and a second push-button (5) for moving the target time display member (6) by another different fraction of an hour, the target time display member (6) moving with respect to the time display member (1, 2) above or beneath which it is arranged.

3. The timepiece according to claim 1, wherein the second control means comprises a first push-button (4) for moving the target time display member (6) by one minute and a second push-button (5) for moving the target time display member (6) by five minutes, the target time display member moving with respect to the time display member (1, 2) beneath which it is arranged.

4. The timepiece according to claim 1, wherein the target time display member (6) is arranged beneath the minute display member (1).

5. The timepiece according to claim 1, wherein the target time display member (6) moves in the clockwise direction when actuated and when the reset means (7) is actuated, the target time display member (6) moves to be stacked above or beneath the minute display member (1) or hour display member (2) in the clockwise or counter-clockwise direction.

6. The timepiece according to claim 1, wherein the hour display member (2), the minute display member (1) and the target time display member (6) are each a hand or another hand-like time indicator member similar to a hand driven in rotation in front of a dial (8) bearing a series of time indications.

7. The timepiece according to claim 1, wherein the hour display member (2), the minute display member (1) and the target time display member (6) are each a disc or a crown.

8. The timepiece according to claim 1, in the form of a wristwatch, a pocket watch, a table clock or a wall clock.
